(19) United States
(12) Patent Application Publication
(10) Pub. No.: US 2018/0162739 A1
(43) Pub. Date: Jun. 14, 2018

(54) METHOD OF MANUFACTURING HIGH-DENSITY BEADS OF HIGH-PURITY ALUMINA

(71) Applicant: SAMHWA YANG HENG CO., LTD., Seoul (KR)

(72) Inventor: Hyeon Cheol BAE, Jeollanam-do (KR)

(21) Appl. No.: 15/814,631

(22) Filed: Nov. 16, 2017

(30) Foreign Application Priority Data
Dec. 9, 2016 (KR) 10-2016-0167267

(51) Int. Cl. C01F 7/34; C01F 7/46; C01F 7/02

(52) U.S. Cl. CPC C01F 7/34; C01F 7/46; C01P 2006/80; C01F 7/022; C01F 7/023

(57) ABSTRACT

A method of manufacturing high-density beads of high-purity alumina, in which general aluminum hydroxide is dissolved in a sodium hydroxide solution. Insoluble impurities are removed to thus manufacture a pure sodium aluminate solution. High-purity aluminum hydroxide is manufactured. The manufactured high-purity aluminum hydroxide is subjected to a hydrothermal reaction, thus removing both crystal water and sodium. Sulfuric acid and ammonia are not used, raw material powder uncontaminated with impurities is manufactured by performing atomization using pulverizing media, and the powder as a raw material and ultrapure water are used to manufacture seeds. While the atomized powder and the ultrapure water are put onto a rotating plate, steps are performed until a desired size is obtained, thus manufacturing highly densified beads. A sintering process is performed in order to maintain a molding shape and to increase a density, followed by a classification process.

### CROSS REFERENCE TO RELATED APPLICATION

The present application claims priority to Korean Patent Application No. 10-2016-0167267, filed Dec. 9, 2016, the entire contents of which are incorporated herein for all purposes by this reference.

### BACKGROUND

### 1. Field of the Invention

The present invention relates to a method of manufacturing high-density beads of high-purity alumina.

### 2. Description of the Background Art

High-density beads of high-purity alumina are chemical products that include the high-purity alumina, which is the raw material of batteries and demand for which has rapidly increased due to the current rapid development of electric and electronic industries, particularly due to the explosive growth of demand for sapphire, LEDs, and secondary batteries.

In order to manufacture the high-density beads of the high-purity alumina, general aluminum hydroxide, manufactured using a Bayer process, is used as a raw material in conventional methods. Since expensive chemical materials such as organic materials, adsorbents, and ammonia sulfate are used, the conventional methods have problems of high energy consumption, wastewater, air pollution, and economic inefficiency. Further, a manufacturing method using aluminum as a raw material has problems of high raw-material costs, high energy consumption, and environmental pollution.

In addition, high-purity alumina powder cannot be used as a filler during the manufacture of a sapphire ingot due to the low density thereof. Therefore, a need for high-density beads, which have high density and excellent sphericity and which facilitate self-filling merely through the addition thereof, has emerged.

### SUMMARY

Accordingly, the present invention has been made keeping in mind the above problems occurring in the related art, and an object of the present invention is to provide a method of manufacturing high-density beads of high-purity alumina.

According to an aspect of the present invention, a method of manufacturing high-density beads which are economical and eco-friendly and has high sphericity is provided. In the method according to the aspect of the present invention, first, general pure aluminum hydroxide is dissolved under predetermined conditions for dissolving sodium hydroxide and insoluble impurities are then removed using a membrane filter, thus manufacturing a pure sodium aluminate mother solution. Seeds are added thereto to precipitate high-purity aluminum hydroxide (Al₂O₃*3H₂O) under optimum precipitation conditions, followed by filtration and washing, thereby manufacturing a high-purity aluminum hydroxide solid matter in a slurry state. After heat treatment for removing crystal water is performed to manufacture Al₂O₃, atomized raw material powder is manufactured using a ball mill and ultrapure water is used to form the seeds. A process for performing molding while the raw material powder and the ultrapure water are put onto a rotating body and a classification process using a standard sieve that is subjected to coating treatment are repeated several times, thus manufacturing a molded body having a desired size. Heat treatment is then performed at 1,400 to 1,800° C. to thus manufacture high-density beads of high-purity alumina having a purity of 99.995% or more.

In a method according to an aspect of the present invention, general aluminum hydroxide is added to a sodium hydroxide solution, thus manufacturing a sodium aluminate solution in which impurities are maximally prevented from being dissolved, with only pure aluminum hydroxide dissolved therein. The sodium aluminate solution is filtered to thus manufacture a high-purity sodium aluminate solution from which impurities are removed. High-purity aluminum hydroxide containing a minimum content of sodium is added as seeds, followed by precipitation and filtering. Next, heat treatment is performed in order to remove a small amount of sodium and some of the crystal water contained in aluminum hydroxide, and aluminum hydroxide containing a small amount of sodium is reacted using distilled water as a solvent, followed by firing, thereby manufacturing eco-friendly high-purity alumina with low energy using a simplified process.

Another aspect of the present invention is to provide a method of manufacturing high-density beads of high-purity alumina, in which high-purity alumina powder has a purity of 99.995% or more. The high-purity alumina powder is manufactured by developing optimum conditions to manufacture the high-purity alumina and which include a weight ratio of a process mother solution, a dissolution temperature, the breathability of a filter cloth, the quantity of seeds used during precipitation, a precipitation temperature, a precipitation time, the weight ratio and the temperature of distilled water and solid matter during a hydrothermal reaction, and a reaction time.

Still another object of the present invention is to provide a method of manufacturing high-density beads of high-purity alumina, in which high-purity alumina powder is atomized using a pulverizer and ultrapure water is used to manufacture seeds. The atomized powder and the ultrapure water are added to perform molding until a predetermined size is obtained, and sintering is then performed, which maintains a molding shape and improves a density, whereby the high-density beads of the high-purity alumina are manufactured.

The aspects of the present invention are not limited to the above-mentioned objects, and other aspects not mentioned can be clearly understood by those skilled in the art from the following description.

An embodiment of a method of manufacturing high-purity alumina according to the present invention includes a mother-solution preparation step of a dissolving process for dissolving general aluminum hydroxide in a sodium hydroxide solution, a purification step that includes a first filtration process for removing impurities not dissolved in a mother solution, a precipitation process for adding seeds to the mother solution to thus perform precipitation, a second filtration process for separating the precipitated slurry solid matter into a filtrate and a solid matter, a hydrothermal process for performing first phase transferring of the solid matter to thus remove the impurities and some of the crystal water, and a third filtration process for removing the impurities, a heat-treatment step of a firing process for removing the crystal water of aluminum hydroxide, from which the impurities have been removed, and a forming step of high-density beads of high-purity alumina using an atomization process for pulverizing particles into particulates having a nano-particle diameter using a pulverizer, a molding process for manufacturing the seeds using only high-purity alumina and ultrapure water and performing stepwise molding for each size, a sintering process for performing heat treatment in order to maintain a molding shape and to improve a density, and a classification process for removing particles having a size that is the same as or larger than a maximum particle size or is the same as or smaller than a minimum particle size in the final product.

The mother-solution preparation step is the dissolving process that is performed at an appropriate content ratio of alumina and sodium hydroxide and reaction temperature for an appropriate dissolving time so that general aluminum hydroxide and sodium hydroxide are put into a dissolver to thus manufacture the mother solution in which only pure aluminum hydroxide is dissolved and from which insoluble impurities are removed.

Another embodiment of a method of manufacturing high-purity alumina according to the present invention includes a dissolving process for putting general aluminum hydroxide and a sodium hydroxide solution into a dissolver to dissolve them, thus forming a mother solution, a first filtration process for removing impurities that are not dissolved after the dissolving process, a precipitation process for adding seeds to the purified mother solution, thus accelerating the precipitation of aluminum hydroxide, a second filtration process for performing separation into a solid matter and a filtrate, transferring the filtrate to the process in order to manufacture the mother solution, transferring a part of the solid matter to the seeds, and transferring the remainder of the solid matter to a hydrothermal reactor after the precipitation process, a hydrothermal process for mixing the manufactured solid matter with distilled water, followed by heating, after the second filtration process, a third filtration process for filtering and washing slurry after the hydrothermal process, a firing process for removing crystal water of aluminum hydroxide, an atomization process for pulverizing particles, thus performing atomization, a molding process for manufacturing the seeds using only high-purity alumina and ultrapure water and performing stepwise molding for each particle size while the atomized powder and the ultrapure water are added, a sintering process for maintaining a molding shape and improving a density, and a classification process for removing particles having a particle size that is larger than a maximum particle size or is smaller than a minimum particle size based on a desired particle size by classification.

In the dissolving process, a weight ratio of aluminum hydroxide to sodium hydroxide is 0.60 to 0.85.

Further, in the dissolving process, a maximum reaction temperature is 110 to 150° C.

Further, in the first filtration process, the temperature of a processing solution is 60 to 80° C. during filtration.

Further, in the first filtration process, the breathability of a filter cloth is 1 μm or less during filtration.

Further, in the precipitation process, the amount of seeds that are used is 1% or more of the weight of the mother solution.

Further, in the precipitation process, the seeds that are used are high-purity aluminum hydroxide, which is the solid matter precipitated in a precipitator.

Further, in the precipitation process, the temperature at which precipitation starts is 55 to 75° C.

Further, in the precipitation process, the precipitation time is 48 hours or more.

Further, in the hydrothermal process, the amount of distilled water that is used is at least 0.4 times greater than the weight of the solid matter.

Further, in the hydrothermal process, the reaction temperature is 250 to 300° C. and the reaction time is 30 min or more.

Further, in the firing process, the temperature at which a change into the high-purity alumina occurs is 1100° C. or higher.

Further, in the atomization process, the size of the atomized particles is less than 1 μm.

Further, in the molding process, the size of the particles used as the seeds is 500 μm or less.

Further, in the molding process, the particle size for each molding step is 500 μm or less.

Further, in the sintering process, a heat-treatment temperature for maintaining the molding shape and improving the density is 1,400° C. or higher.

One or more embodiments of the present invention have the following excellent effects.

According to a method of manufacturing high-density beads of high-purity alumina according to an embodiment of the present invention, a supersaturated solution of sodium aluminate is manufactured at a high concentration in order to remove impurities, which impede the precipitation of products, prevent the occurrence of waste matter on which impurities are adsorbed, and reduce energy usage due to the use of an adsorbent using a simple method in which the adsorbent, which is used in a conventional method, is not further used. Further, inorganic acid and alkali are used in order to remove sodium impurities which are present in aluminum hydroxide in a conventional technology, thus completely solving problems related to increased manufacturing costs, wastewater, and air pollution, whereby process simplification, low energy use, a reduction in raw-material costs, and an innovative eco-friendly manufacturing method are secured. Further, unlike the conventional manufacturing method, in which productivity is poor due to the low density and the low filling density, productivity is excellent, a raw material having high density and sphericity can be used in self-filling, economic efficiency is secured, and a working environment is excellent.

### BRIEF DESCRIPTION OF THE DRAWING

FIG. 1 is a block diagram showing a method of manufacturing high-density beads of high-purity alumina according to an embodiment of the present invention.

### DETAILED DESCRIPTION

While the present invention has been described using terms relating to what is presently considered to be the most practical and preferred embodiment, in certain cases, there may be a term arbitrarily selected by the applicant, in which case the meaning thereof should be understood based not on the name of a simple term but on the meaning of the term described or used in the detailed description of the invention.

Hereinafter, the technical constitution of the present invention will be described in detail with reference to preferred embodiments shown in the accompanying drawings.

However, the present invention is not limited to the embodiments described herein, but may be embodied in other forms. Like reference numerals denote like elements throughout the specification.

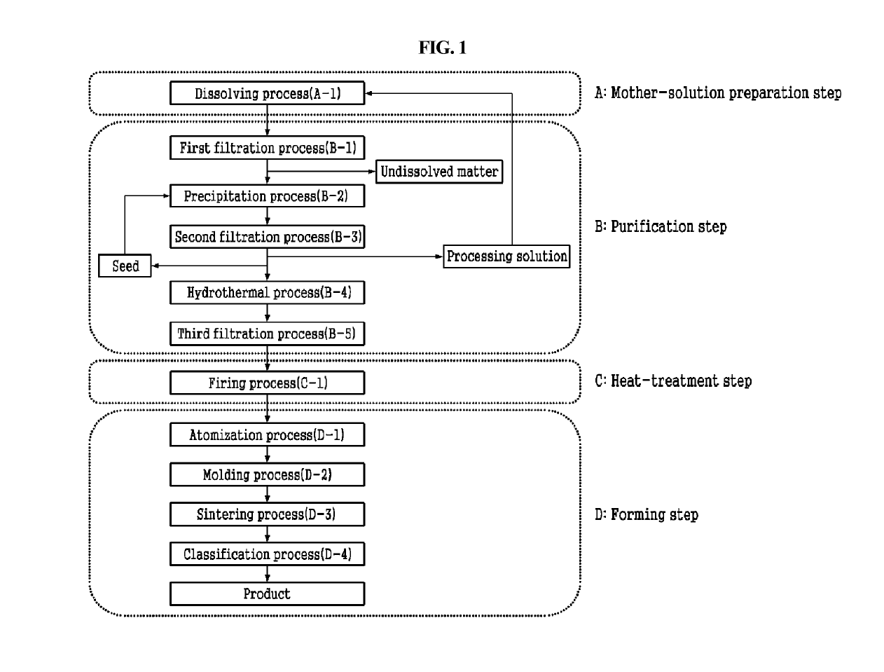

FIG. 1 is a block diagram showing a method of manufacturing high-density beads of high-purity alumina according to an embodiment of the present invention.

Referring to FIG. 1, a method of manufacturing high-density beads of high-purity alumina according to an embodiment of the present invention includes (A) a mother-solution preparation step of dissolving general aluminum hydroxide in a sodium hydroxide solution so as to be supersaturated, (B) a purification step of removing insoluble impurities using a filter having low breathability, adding seeds to thus recrystallize aluminum hydroxide, and performing mixing with distilled water and heating at high temperatures, thereby removing some of the crystal water and the impurities, after the mother-solution preparation step (A), (C) a heat-treatment step of calcining the remainder of the crystal water, and (D) a forming step of the high-density beads of the high-purity alumina. In step (D), atomized powder is mixed with ultrapure water to form the seeds, the seeds are subjected to a molding process for each particle size to form a final molded body, sintering is performed to maintain a molding shape and to secure high densification, and a classification process for removing particles having a particle size that is the same as or larger than a maximum particle size or is the same as or smaller than a minimum particle size of a final product is performed, thereby forming the final product.

Particularly, in the purification step (B), aluminum hydroxide is supersaturated and dissolved so as to completely solve problems such as a loss of products, an increase of waste, and energy consumption, caused by co-precipitation and the adsorbent used in order to remove the impurities from the mother solution in the conventional technology. Accordingly, since other impurities are not dissolved, the impurities are removed using only simple filtration, and the extent of supersaturation is high, so that productivity is at least 20% higher than that of the conventional technology.

Conventionally, a large amount of organic acid and inorganic acid is used in order to remove a small amount of sodium impurities from the purified aluminum hydroxide obtained during the reaction, which causes an increase in raw-material costs and an environmental problem. However, in an embodiment of the present invention, the sodium impurities contained in the purified aluminum hydroxide are subjected to a hydrothermal reaction so that the crystal water and the sodium impurities are eluted in distilled water without using any organic or inorganic acid, thereby achieving purification.

Further, the raw material that is used is atomized via the atomization process, which is completely different from the conventional manufacturing method, and only the atomized powder and the ultrapure water are used to thus manufacture a molded body, thereby contributing to the improvement of sphericity and density and also remarkably improving productivity, including filling density or self-filling, compared to a conventional low-density powder.

Another embodiment of a method of manufacturing high-purity alumina according to an embodiment of the present invention, as shown in FIG. 1, includes (A-1) a dissolving process for putting general aluminum hydroxide and a sodium hydroxide solution into a dissolver to form a mother solution so that a supersaturated solution of sodium aluminate is manufactured, (B-1) a first filtration process for removing insoluble impurities and transferring the purified mother solution to a precipitator after the dissolving process, (B-2) a precipitation process for adding high-purity aluminum hydroxide seeds to the mother solution of the precipitator of the first filtration process, thus re-crystallizing high-purity aluminum hydroxide, (B-3) a second filtration process for filtering a precipitate, transferring a filtrate to the dissolver used to manufacture the mother solution, using a part of the precipitate as the seeds in the precipitator, washing the remainder of the precipitate, and transferring the washed precipitate to a hydrothermal reaction vessel after the precipitation process, (B-4) a hydrothermal reaction for adding distilled water to the hydrothermal reaction vessel and performing heating so that phase transition of aluminum hydroxide to boehmite occurs and thus a small amount of sodium impurities contained in aluminum hydroxide is eluted into the distilled water after the second filtration process, (B-5) a third filtration process for washing solid matter and transferring the washed solid matter to a firing process after the hydrothermal reaction, (C-1) a firing process for calcining high-purity boehmite to thus manufacture high-purity alpha-alumina after the third filtration process, (D-1) an atomization process for performing pulverization into atomized powder using a pulverizer, (D-2) a molding process for manufacturing the seeds using the atomized powder and the ultrapure water and performing molding using the seeds until desired particles are obtained while the atomized powder and the ultrapure water are stepwisely added for each particle size, (D-3) a sintering process for performing heat treatment in order to maintain a molding shape and to improve a density, and (D-4) a classification process for removing particles having a particle size that is the same as or larger than a maximum particle size or is the same as or smaller than a minimum particle size in desired particles by classification.

Hereinafter, a method of manufacturing high-density beads of high-purity alumina according to an embodiment of the present invention will be described in more detail.

For the manufacture of a sodium aluminate mother solution, a sodium hydroxide solution was diluted to 320 g/L based on sodium carbonate, and was put into a 300 L dissolver which was made of SUS316 and which was equipped with a stirrer. General aluminum hydroxide containing the impurities shown in Table 1 was then added until a weight ratio of Al₂O₃/Na₂CO₃ (represented by A/C) was 0.78, was stirred, was heated to 140° C. and was then maintained for 1 hour, thus manufacturing the sodium aluminate mother solution (dissolving process, A-1). Thereafter, the temperature was reduced, the temperature of the mother solution was maintained at 72° C., and filtration was performed using a linear filter provided with a filter cloth having a breathability of 1 μm or less (filter cloth material: PE, housing: SUS316), thus removing insoluble impurities and transferring the purified filtrate to a precipitator (first filtration process, B-1).

The process mother solution from which the impurities were removed was maintained in a precipitator so that an A/C value was 0.78, a C value was 320 g/L, and the temperature was 65° C. In order to accelerate precipitation, 3 wt % of the high-purity aluminum hydroxide was added all at once to the mother solution, and the temperature was reduced to 45° C. with slow stirring for 72 hours, thereby inducing precipitation. When the precipitation was completed, a slurry having an A/C value of 0.28 and a C value of 340 g/L was manufactured (precipitation process, B-2).

After the precipitation process is completed, the filtration was performed using a second filter. The filtrate was transferred to the dissolver in order to manufacture the mother solution, part of the solid matter was used as seeds, the remainder of the solid matter was washed using warm water and filtered, and the filtered solid matter having the purity shown in Table 1 was transferred to a hydrothermal reaction vessel (second filtration process, B-3).

The slurry in which the washed solid matter and the ultrapure water were mixed was heated to 270° C. for 2 hours in the hydrothermal reaction vessel, was maintained for 1 hour, was cooled to 80° C., and was then filtered using a third filter (hydrothermal process, B-4).

The filtered solid matter in the hydrothermal reaction vessel was again washed with warm water and filtered, thus manufacturing the purified high-purity boehmite cake containing 20% of water shown in Table 1 (third filtration process, B-5).

The high-purity boehmite manufactured during the third filtration process was put into a high-purity alumina crucible and was placed in a high-temperature firing furnace. Subsequently, the temperature was raised at 2° C./min and was maintained at 1200° C. for 2 hours. Cooling to room temperature was performed, thereby manufacturing high-purity alumina powder having a purity of 99.999% or more shown in Table 1 (firing process, C-1).

The granules manufactured during the firing process were put into a dry pulverizer, and were rotated at 120 rpm for 1 hour so as to be pulverized until a particle size thereof was 1 μm or less, thus manufacturing atomized powder (atomization process, D-1).

The seeds having a size of 0.5 μm were manufactured using the atomized powder and the ultrapure water, and were put onto a rotating plate rotating at 90 rpm to rotate the same. While the atomized powder and the ultrapure water were added, molding was performed until an average particle diameter of 1.0 μm was obtained, followed by discharging and classification. Further addition was performed, and molding was performed until 1.5 μm was obtained, followed by discharging and classification, thereby manufacturing particles having a desired particle diameter shown in Table 2 (molding process, D-2).

TABLE 1
Content of impurities in each process according to an
embodiment of the present invention (unit: ppm)

| | | | | High-purity |
|---|---|---|---|---|
| | | Purified | | alumina |
| | | aluminum | High-purity | manufactured by |
| | General | hydroxide | boehmite after | an embodiment |
| | aluminum | after | hydrothermal | of the present |
| Classification | hydroxide | precipitation | reaction | invention |
| Na content | 4,000 | 1,000 | 2 | 2 |
| Si content | 120 | 3 | 2 | 2 |
| Fe content | 95 | 0.5 | 0.5 | 0.5 |
| Ti content | 37 | 0.2 | 0.1 | 0.1 |
| Ca content | 104 | 1.7 | 0.3 | 0.3 |

TABLE 2
Particle size for each step according to an embodiment of the
present invention (unit: μm)

| | | First | Second | Third | Fourth |
|---|---|---|---|---|---|
| Classification | Seed | molding | molding | molding | molding |
| Average particle | 0.5 | 1.0 | 1.5 | 2.0 | 2.5 |
| diameter | | | | | |

Sintering was performed at 1,600° C. in order to maintain the shape of the molded beads and to increase the density thereof. Since a sintering shrinkage ratio is determined to be 10 to 35% according to a sintering temperature, in the molding process, a molding size must be determined in advance so as to be suitable for the sintering shrinkage. The sintering temperature was maintained at 1,600° C., which was a temperature before the surfaces of the particles were fused due to overheating for 1 hour, thus manufacturing the beads (sintering process, D-3).

The sintered beads were passed through a surface-treated standard sieve in order to separate inferior products including particles having a particle size larger than a maximum particle size or smaller than a minimum particle size, thus preventing the particles from being fused and also preventing over-sintering. In the surface treatment, all surfaces that may come into direct contact with the molded beads must be coated in order to fundamentally prevent the incorporation of impurities. A PE, PP, Teflon, alumina spray coating or nylon material, which was a liquid or powder surface-treating material, was spun using various methods, thus manufacturing the standard sieve (classification process, D-4).

Although the exemplary embodiments of the present invention have been disclosed for illustrative purposes, those skilled in the art will appreciate that the present invention is not limited to the disclosed embodiments but that various modifications and additions are possible without departing from the spirit of the invention as disclosed in the accompanying claims.

What is claimed is:

1. A method of manufacturing high-density beads of high-purity alumina, the method comprising:
a mother-solution preparation step of putting general aluminum hydroxide and a sodium hydroxide solution into a dissolver and performing heating to thus form a supersaturated liquid;
a purification step that includes a first filtration process for filtering a mother solution using a filter cloth to thus remove insoluble impurities and transferring the purified mother solution to a precipitator, a precipitation process for adding high-purity aluminum hydroxide seeds to the mother solution of the precipitator, thus precipitating high-purity aluminum hydroxide, a second filtration process for separating the precipitated high-purity aluminum hydroxide and the sodium hydroxide solution, which includes a part of the aluminum hydroxide dissolved therein, transferring a filtrate back to the process and washing a solid matter, a hydrothermal process for mixing the washed high-purity aluminum hydroxide with distilled water and putting a mixture into a high-pressure reactor, followed by a reaction at 250 to 300° C., thus removing some of the crystal water from Al₂O₃*H₂O, and a third filtration process for separating the water and the solid matter after the hydrothermal process;
a heat-treatment step of performing heat treatment and firing at a high temperature in order to remove the crystal water after the third filtration process; and
a forming step of the high-density beads of the high-purity alumina, which includes an atomization process for pulverizing particles into fine particulates after the heat-treatment step, a molding process for performing molding into beads having a predetermined size after the atomization process, a sintering process for performing the heat treatment at a high temperature after the molding process, and a classification process for sorting the particles after the sintering process.

2. The method of claim 1, wherein during the mother-solution preparation step, the heating is performed at a temperature condition of 110 to 150° C. for 1 to 4 hours to cause dissolving.

3. The method of claim 1, wherein during the first filtration process, the mother solution is filtered using the filter cloth at a temperature condition of 60 to 80° C. to thus remove the impurities.

4. The method of claim 3, wherein the filter cloth includes a PE or Teflon material and has a breathability of 1 μm or less.

5. The method of claim 1, wherein during the precipitation process, a reaction-starting temperature is 55 to 75° C. and a reaction-finishing temperature is 35 to 55° C.

6. The method of claim 5, wherein the precipitation process is performed for 48 to 96 hours.

7. The method of claim 1, wherein the seeds used during the precipitation process have a purity that is identical with or higher than a purity of the high-purity aluminum hydroxide.

8. The method of claim 7, wherein during the precipitation process, the seeds are used in an amount of 3 vol % or more and preferably 5 to 10 vol % based on a purified mother solution.

9. The method of claim 1, wherein during the hydrothermal process, the reaction is performed at a temperature of 200 to 300° C. for a maintenance time of 30 min to 2 hours.

10. The method of claim 1, wherein during a reaction of the third filtration process, ultrapure water is used in an amount that is at least 0.5 times and preferably 1 to 10 times more than a weight of the high-purity aluminum hydroxide.

11. The method of claim 1, wherein the heat-treatment step is performed at a firing temperature of 800° C. or higher and preferably 1,100 to 1,300° C., thus performing pregelatinization.

12. The method of claim 1, wherein the particles are atomized until an average particle diameter of 100 to 900 nm is obtained using a dry pulverizer and pulverizing media, which is directly manufactured with the high-purity alumina, during the atomization process.

13. The method of claim 1, wherein during the molding process, the seeds having a size of 100 μm or more and preferably 500 to 1,000 μm are formed from an atomized powder using ultrapure water, and while the atomized powder and the ultrapure water are put onto a rotating plate that rotates at 30 to 150 rpm, the molding and classification are repeated in a unit of 500 μm until a desired size is obtained, thus molding the beads having a high density.

14. The method of claim 1, wherein during the sintering process, a molded product is heat-treated at 1,400° C. or higher and preferably 1,500 to 1,650° C., thus maintaining a molding shape and increasing a density thereof.

15. The method of claim 1, wherein during the classification process, only particles remaining between two standard sieves having maximum and minimum particle diameters are sorted in order to obtain particles having a desired particle size.
